(19) United States
(12) Patent Application Publication
(10) Pub. No.: US 2003/0122763 A1
(43) Pub. Date: Jul. 3, 2003

(54) Liquid crystal display device and method of fabricating the same

(75) Inventor: Hong Man Moon, Kyongsangbuk-do (KR)

Correspondence Address: MORGAN LEWIS & BOCKIUS LLP, 1111 PENNSYLVANIA AVENUE NW, WASHINGTON, DC, 20004, US

(73) Assignee: LG. Philips LCD Co., Ltd.

(21) Appl. No.: 10/319,563

(22) Filed: Dec. 16, 2002

(30) Foreign Application Priority Data
Dec. 29, 2001 (KR) P2001-0088439

(51) Int. Cl. G09G 3/36

(52) U.S. Cl. 345/93

(57) ABSTRACT

A liquid crystal display device and a method of fabricating the same are disclosed in the present invention. The display device includes a first substrate having a liquid crystal display panel region divided by a pixel area and a dummy area, wherein a plurality of thin film transistors and pixel electrodes are formed in the liquid crystal display panel region, a second substrate having a black matrix, a sealant located in a peripheral region of the liquid crystal display panel region between the first and second substrates, a plurality of column spacers only in the pixel area of the liquid crystal display panel region, and a liquid crystal layer between the first and second substrates.

This application claims the benefit of the Korean Application No. P2001-088439 filed on Dec. 29, 2001, which is hereby incorporated by reference.

### BACKGROUND OF THE INVENTION

1. Field of the Invention

The present invention relates to a display device, and more particularly, to a liquid crystal display device and a method of fabricating the same. Although the present invention is suitable for a wide scope of applications, it is particularly suitable for uniformly forming a liquid crystal layer of the liquid crystal display device.

2. Discussion of the Related Art

Since a liquid crystal display device tends to be slim, it is critical to maintain a cell gap between the thin film transistor substrate and the color filter substrate with a constant interval. This is because the cell gap has a close relationship to the display characteristics of the liquid crystal display device, such as response speed, contrast, viewing angle, color tone, and the like.

As a method of uniformly maintaining the cell gap, a method of scattering micro-ball type spacers is used in a liquid crystal cell. A ball type spacer is made of glass, plastic, or the like.

Lately, a fixed type spacer bonded to the substrate is more popular in order to prevent damage in image quality caused by the ball type spacer. Also, a column spacer patterned directly on the substrate using photolithography has been proposed in forming spacers.

A liquid crystal display device according to a related art is explained by referring to the attached drawings as follows.

FIG. 1 illustrates a cross-sectional view of a liquid crystal display device according to a related art.

Referring to FIG. 1, a related liquid crystal display device includes a first substrate 11 having thin film transistors (not shown) as switching devices formed thereon, a second substrate 11a having a color filter layer (not shown) formed thereon, a liquid crystal layer 15 formed between the first and second substrates 11 and 11a, a sealant 17 formed on the circumferences of the first and second substrates 11 and 11a so as to bond the first and second substrates 11 and 11a to each other as well as to protect the liquid crystal layer 15, and a column spacer 13 formed to maintain a cell gap between the first and second substrates 11 and 11a.

In this case, the column spacer 13 maintains the cell gap when the first and second substrates 11 and 11a with the sealant 17 are bonded to each other.

A liquid crystal display device is fabricated by either a vacuum injection or liquid crystal dropping process depending upon a method of forming the liquid crystal layer 15.

FIG. 2A illustrates a layout of a substrate for vacuum injection.

Referring to FIG. 2A, a liquid crystal display device fabricated by vacuum injection includes a column spacer formed on a second substrate 11a with color filters (not shown) and common electrodes (not shown) so as to maintain a cell gap and a sealant 17 formed on the second substrate 11a so as to bond the second substrate to a first substrate 11 having thin film transistors and pixel electrodes formed thereon. In this case, a liquid crystal injection inlet 14 is provided in the sealant 17 on the edge of the second substrate 11a.

In order to form the liquid crystal layer 15 in the liquid crystal display device of vacuum injection, liquid crystals are injected through the liquid crystal injection inlet 14 after bonding the first and second substrates 11 and 11a to each other. In this case, the liquid crystals flow inside the liquid crystal display panel due to a pressure difference between the inner and outer spaces of the liquid crystal display panel.

FIG. 2B illustrates a layout of a substrate for liquid crystals dropping.

Referring to FIG. 2B, a liquid crystal display device fabricated by liquid crystal dropping includes a column spacer formed on a second substrate 11a with color filters so as to maintain a cell gap and a sealant 17 formed on the circumference of the second substrate 11a without a liquid crystal injection inlet.

In order to form the liquid crystal layer 15 in the liquid crystal display device of liquid crystal dropping, the first and second substrates 11 and 11a are bonded to each other after liquid crystals are dropped on the second substrate 11a with the sealant 17 formed thereon.

Therefore, compared to the vacuum injection, liquid crystal dropping has an advantage in reducing a process time of fabricating the liquid crystal display device and a raw material of liquid crystals.

The liquid crystal display device fabricated by liquid crystal dropping is explained in detail as follows.

FIG. 3 illustrates a layout of a liquid crystal display device according to a related art.

Referring to FIG. 3, a related art liquid crystal display device includes, a first substrate including a liquid crystal display panel region having a pixel area 18a and a dummy area 18b, a plurality of pixel electrodes 12 formed in the liquid crystal display panel region, a black matrix 16 formed in the liquid crystal display panel region on a second substrate, column spacers 13 and auxiliary column spacers 13a formed in the pixel area 18a and the dummy area 18b on the black matrix 16 so as to maintain a liquid crystal cell gap, and a sealant 17 formed in the peripheral region of the liquid crystal display panel region on the second substrate 11a defining and protecting a liquid crystal layer formed by the liquid crystal dropping process.

The auxiliary column spacers 13a are formed in the dummy area 18b so as to buffer a shock on the circumference of the sealant 17 when the bonded first and second substrates 11 and 11a are cut into unit panels.

Arrows in FIG. 3 indicate directions to which the dropped dispensed liquid crystals (not shown) are spread.

The dropped liquid crystals move toward the edges of the second substrate 11a. The liquid crystals 15 dropped on the second substrate 11a spread so as to form the planarized liquid crystal layer.

However, the related art liquid crystal display device has the following disadvantages or problems.

In the related art liquid crystal display device, the auxiliary column spacers 13a formed in the dummy area 18b for absorbing the shock around the sealant act as a resistance against the flow of the dropped liquid crystals. Moreover, since the liquid crystals have high viscosity, it is difficult for them to smoothly move to the small space.

Hence, the dispensed liquid crystals are inhibited by the column spacer formed in the dummy area of the liquid crystal display panel, whereby bubbles are generated from the dummy area of the liquid crystal display panel while the liquid crystal layer is formed.

### SUMMARY OF THE INVENTION

Accordingly, the present invention is directed to a liquid crystal display device and a method of fabricating the same that substantially obviates one or more of problems due to limitations and disadvantages of the related art.

Another object of the present invention is to provide a liquid crystal display device and a method of fabricating the same that enable to reliably form by forming column spacers only in the pixel area.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes a first substrate having a liquid crystal display panel region divided by a pixel area and a dummy area, wherein a plurality of thin film transistors and pixel electrodes are formed in the liquid crystal display panel region, a second substrate having a black matrix, a sealant located in a peripheral region of the liquid crystal display panel region between the first and second substrates, a plurality of column spacers only in the pixel area of the liquid crystal display panel region, and a liquid crystal layer between the first and second substrates.

In another aspect of the present invention, a liquid crystal display device includes first and second substrates having a liquid crystal display panel region divided by a pixel area and a dummy area, gate and data lines crossing each other in the liquid crystal display panel region on the first substrate, a plurality of thin film transistors at intersections of the gate and data lines, a black matrix and a color filter layer in the liquid crystal display panel region on the second substrate, a sealant in a peripheral region of the liquid crystal display panel region between the first and second substrates, a plurality of column spacers on the color filter layer only in the pixel area, and a liquid crystal layer formed between the first and second substrates, wherein the liquid crystal layer is surrounded by the sealant.

The present invention is characterized in that column spacers are formed in the pixel areas only so as to provide a uniform distribution of the liquid crystals dispensed by liquid crystals dropping. Therefore, the present invention prevents a liquid crystal depletion in a bonding process of the first and second substrates.

In another aspect of the present invention, a method of forming a liquid crystal display device includes forming a first substrate having a liquid crystal display panel region divided by a pixel area and a dummy area, wherein a plurality of thin film transistors and pixel electrodes are formed in the liquid crystal display panel region, forming a second substrate having a black matrix, forming a sealant located in a peripheral region of the liquid crystal display panel region between the first and second substrates, forming a plurality of column spacers only in the pixel area of the liquid crystal display panel region, and forming a liquid crystal layer between the first and second substrates.

In a further aspect of the present invention, a method of forming a liquid crystal display device includes forming first and second substrates having a liquid crystal display panel region divided by a pixel area and a dummy area, forming gate and data lines crossing each other in the liquid crystal display panel region on the first substrate, forming a plurality of thin film transistors at intersections of the gate and data lines, forming a black matrix and a color filter layer in the liquid crystal display panel region on the second substrate, forming a sealant in a peripheral region of the liquid crystal display panel region between the first and second substrates, forming a plurality of column spacers on the color filter layer only in the pixel area, and forming a liquid crystal layer between the first and second substrates, wherein the liquid crystal layer is surrounded by the sealant.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 illustrates a cross-sectional view of a liquid crystal display device according to a related art;

FIG. 2A illustrates a layout of a substrate for vacuum injection;

FIG. 2B illustrates a layout of a substrate for liquid crystals dropping;

FIG. 3 illustrates a layout of a liquid crystal display device according to a related art;

FIG. 4 illustrates a layout of a liquid crystal display device according to the present invention; and

FIG. 5 illustrates a cross-sectional view taken along line V-V in FIG. 4.

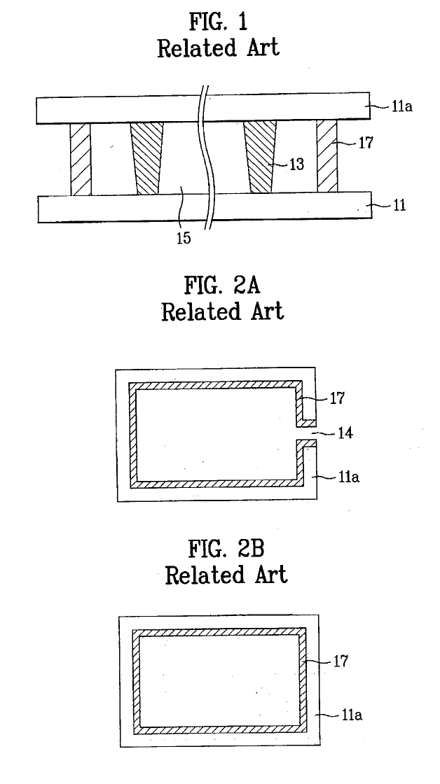

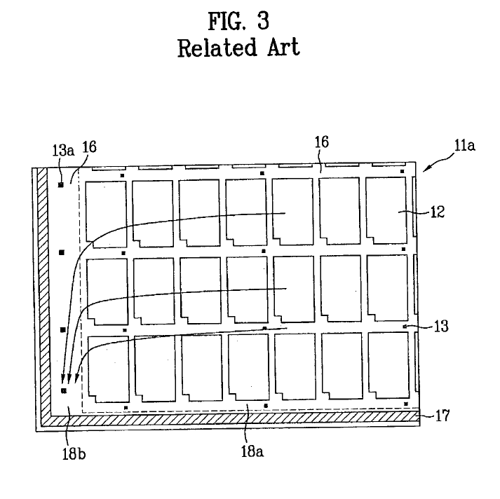

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

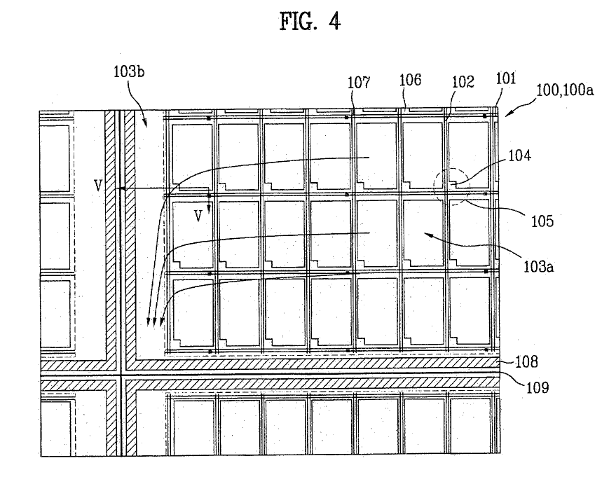

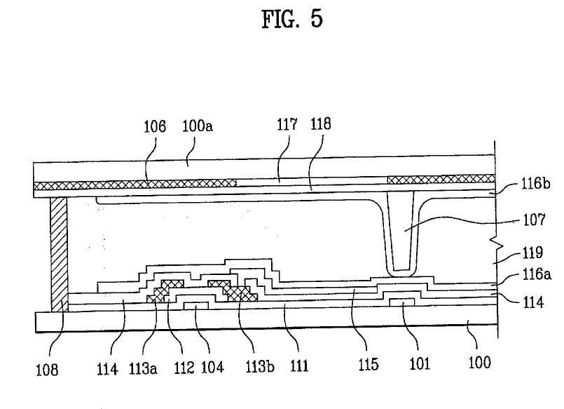

FIG. 4 illustrates a layout of a liquid crystal display device according to the present invention.

Referring to FIG. 4, a plurality of LCD panel regions are arranged on first and second substrates, and each LCD panel region has a pixel area 103a and a dummy area 103b. According to the present invention, a liquid crystal display device according to the present invention includes a plurality of gate and data lines 101 and 102 crossing each other in each LCD panel region on the first substrate 100 defining a plurality of pixel regions, a plurality of pixel electrodes formed in each pixel regions, a plurality of thin film transistors 105 formed at each intersection of the gate lines and data lines 101 and 102 to switch electrical signals applied to the pixel electrodes, a first alignment layer (not shown) providing alignment directions to liquid crystals formed on the first substrate 100, a black matrix 106 formed on a second substrate 100a facing into the first substrate 100 so as to prevent light leakage, a color filter layer (not shown) formed on the black matrix 106, and a common electrode formed on the black matrix 106 and the color filter layer.

The liquid crystal display device according to the present invention further includes column spacers 107 formed only in the pixel area 103a on the common electrode between the pixel electrodes, a second alignment layer (not shown) formed on the second substrate having the column spacers 107, and a sealant 108 formed in the peripheral region of the LCD panel region between the first and second substrates 100 and 100a so as to bond the first and second substrates 100 and 100a to each other.

In this case, each of the thin film transistors has a gate electrode 104 and source/drain electrodes. And, a liquid crystal layer (not shown) surrounded by the sealant 108 is formed between the first and second substrates 100 and 100a. The liquid crystal layer is formed in a manner that liquid crystals are dispensed in the pixel and dummy areas 103a and 103b by liquid crystal dropping.

And, scribing lines 109 are formed on the first and second substrates having a plurality of LCD panel region and in parallel with the sealant 108 for separating the LCD panels from each other.

Arrows in FIG. 4 indicate spreading directions of the dispensed liquid crystals on the first substrate 100 or the second substrate 100a.

The dispensing of the liquid crystals is carried out by a previously calculated method, and the dispensed liquid crystals move toward the edges of each of the LCD panel regions. After a predetermined period of time, the liquid crystals dropped on the first substrate 100 or the second substrate 100a spread evenly so as to form a planarized liquid crystal layer.

More specifically, the LCD panel region surrounded by the sealant 108 on the first substrate 100 or the second substrate 100a is divided into the pixel and dummy areas 103a and 103b, and the column spacers 107 are formed only in the pixel area 103a.

Unlike the related art liquid crystal display device, the liquid crystal display according to the present invention does not have a column spacer formed in the dummy area 103b.

The liquid crystal display device according to the present invention is explained in detail by referring to the attached drawing as follows.

FIG. 5 illustrates a cross-sectional view taken along line V-V in FIG. 4.

Referring to FIG. 5, a liquid crystal display device according to the present invention includes a gate line 101 formed in the LCD panel region on a first substrate 100, a gate electrode 104 protruding from the gate line 101, a gate insulating layer 111 formed on the entire surface of the first substrate 100 including the gate line 101, an island-shaped semiconductor layer 112 formed on the gate insulating layer 111 over the gate electrode 104, source/drain electrodes 113a and 113b formed at the right and left sides of the semiconductor layer 112, a passivation layer 114 formed on the entire surface including the source/drain electrodes 113a and 113b, a pixel electrode 115 formed on the passivation layer 114 so as to be electrically connected to the drain electrode 113b, and a first alignment layer 116a formed on the passivation layer 114 and the pixel electrode 115 so as to align liquid crystals. In this case, the gate electrode 110, the semiconductor layer 112, and the source/drain electrodes 113a and 113b constitute a thin film transistor (i.e., ‘105’ in FIG. 4).

Moreover, the liquid crystal display device according to the present invention further includes a black matrix 106 formed in the LCD panel region on a second substrate 100a facing into the first substrate 100 to shield light, a color filter layer 106 for realizing colors, a common electrode 118 formed on the black matrix 106 and the color filter layer 117 so as to have a voltage difference from the pixel electrode 115, a column spacer 107 formed in a pixel area 103a on the common electrode 118 so as to maintain a predetermined space from the first substrate 100, a second alignment layer 116b formed on the column spacer 107 and the common electrode 118, a sealant 108 formed in the peripheral region of the LCD panel region between the first and second substrates 100 and 100a, and a liquid crystal layer 119 between the first and second substrates 100 and 100a.

The present invention may also be applicable to various modes, such as TN, IPS, VA, reflective, ferroelectric, and the like.

In this case, the column spacer 107 is formed on the common electrode 118 overlapping the black matrix so as not to inhibit light transmittance in the pixel area 103a.

Moreover, The column spacer is not formed in the dummy area 103b but in the pixel area 103a, thereby enabling to evenly spread liquid crystals when the liquid crystal layer 119 is formed by liquid crystal dropping. Therefore, the liquid crystal layer 119 can be reliably formed so that yield is improved.

Accordingly, the liquid crystal display device according to the present invention has the following advantage.

The column spacers are formed only in the pixel area, whereby the liquid crystals are evenly dispensed in the dummy area when the liquid crystal layer is formed using liquid crystal dispensing. Therefore, the liquid crystal layer can be reliably formed in the present invention.

It will be apparent to those skilled in the art that various modifications and variations can be made in the liquid crystal display device and the method of fabricating the same of the present invention without departing from the spirit or scope of the inventions. Thus, it is intended that the present invention covers the modifications and variations of this invention provided they come within the scope of the appended claims and their equivalents.

What is claimed is:

1. A liquid crystal display device, comprising:
a first substrate having a liquid crystal display panel region divided by a pixel area and a dummy area, wherein a plurality of thin film transistors and pixel electrodes are formed in the liquid crystal display panel region;
a second substrate having a black matrix;
a sealant located in a peripheral region of the liquid crystal display panel region between the first and second substrates;
a plurality of column spacers only in the pixel area of the liquid crystal display panel region; and
a liquid crystal layer between the first and second substrates.

2. The device of claim 1, wherein the column spacers are formed between the pixel electrodes.

3. The device of claim 1, wherein the column spacers are formed on the black matrix.

4. The device of claim 1, further comprising an alignment layer on the column spacers and the second substrate.

5. A liquid crystal display device, comprising:
first and second substrates having a liquid crystal display panel region divided by a pixel area and a dummy area;
gate and data lines crossing each other in the liquid crystal display panel region on the first substrate;
a plurality of thin film transistors at intersections of the gate and data lines;
a black matrix and a color filter layer in the liquid crystal display panel region on the second substrate;
a sealant in a peripheral region of the liquid crystal display panel region between the first and second substrates;
a plurality of column spacers on the color filter layer only in the pixel area; and
a liquid crystal layer between the first and second substrates, wherein the liquid crystal layer is surrounded by the sealant.

6. The device of claim 5, wherein the column spacers are formed to vertically overlap the gate lines.

7. The device of claim 5, wherein the column spacers are formed on the color filter layer overlapping the black matrix.

8. The device of claim 5, further comprising an alignment layer on the column spacers.

9. A method of forming a liquid crystal display device, comprising:
forming a first substrate having a liquid crystal display panel region divided by a pixel area and a dummy area, wherein a plurality of thin film transistors and pixel electrodes are formed in the liquid crystal display panel region;
forming a second substrate having a black matrix;
forming a sealant located in a peripheral region of the liquid crystal display panel region between the first and second substrates;
forming a plurality of column spacers only in the pixel area of the liquid crystal display panel region; and
forming a liquid crystal layer between the first and second substrates.

10. The method of claim 9, wherein the column spacers are formed between the pixel electrodes.

11. The method of claim 9, wherein the column spacers are formed on the black matrix.

12. The method of claim 9, further comprising forming an alignment layer on the column spacers and the second substrate.

13. A method of forming a liquid crystal display device, comprising:
forming first and second substrates having a liquid crystal display panel region divided by a pixel area and a dummy area;
forming gate and data lines crossing each other in the liquid crystal display panel region on the first substrate;
forming a plurality of thin film transistors at intersections of the gate and data lines;
forming a black matrix and a color filter layer in the liquid crystal display panel region on the second substrate;
forming a sealant in a peripheral region of the liquid crystal display panel region between the first and second substrates;
forming a plurality of column spacers on the color filter layer only in the pixel area; and
forming a liquid crystal layer between the first and second substrates, wherein the liquid crystal layer is surrounded by the sealant.

14. The method of claim 13, wherein the column spacers are formed to vertically overlap the gate lines.

15. The method of claim 13, wherein the column spacers are formed on the color filter layer overlapping the black matrix.

16. The method of claim 13, further comprising forming an alignment layer on the column spacers.
